(19) United States
(12) Patent Application Publication
(10) Pub. No.: US 2006/0072381 A1
(43) Pub. Date: Apr. 6, 2006

(54) Apparatuses and methods for laser processing of head suspension components

(75) Inventor: Mark T. Girard, Hutchinson, MN (US)

Correspondence Address: Kevin J. Hubbard;Kagan Binder, PLLC, Maple Islond Building, Suite 200, 221 Main Street North, Stillwater, MN, 55082, US

(73) Assignee: Applied Kinetics, Inc.

(21) Appl. No.: 10/940,160

(22) Filed: Sep. 13, 2004

(51) Int. Cl. G11B 7/085; G11B 5/09

(52) U.S. Cl. 369/30.27

(57) ABSTRACT

Apparatuses and methods for determining and adjusting a performance parameter of a head suspension or a head suspension assembly, such as static attitude, are provided. An apparatus in accordance with the present invention includes a measurement probe, such as an autocollimator, and a tool head. The tool head includes a working region and an optical system that can be used to selectively deliver an adjust beam to oppositely facing surfaces of a head suspension or head suspension assembly positioned in the working region for adjusting a performance parameter. Methods of adjusting performance parameters with such an apparatus are also provided by the present invention.

### TECHNICAL FIELD

The present invention relates to apparatuses and methods for determining and adjusting one or more performance parameters of a head suspension or head suspension assembly of the type generally used in dynamic storage devices such as magnetic disk drives. In particular, the present invention relates to apparatuses and methods that use a laser based technique to adjust a performance parameter.

### BACKGROUND

Head suspensions are well known and commonly used within dynamic magnetic or optical information storage devices or drives with rigid disks. The head suspension is a component within the disk drive that positions a magnetic or optical read/write head over a desired location on the storage media. Head suspensions for use in rigid disk drives typically comprise a three-piece construction having a load beam, a flexure, and a baseplate. The load beam typically includes a proximal end for attachment to the baseplate, a rigid region extending toward a distal end, and a spring region between the rigid region and the base for providing a bias force. The flexure, located at the distal end of the load beam, has a pad or tongue to which a slider capable of supporting a read/write head can be mounted. Head suspensions are normally combined with an actuator arm or E-block to which the baseplate is mounted for positioning the head suspension, and thus the slider and read/write head, with respect to data tracks of the rigid disk.

The flexure permits pitch and roll motion of the slider and read/write head as they move over the data tracks of the disk. The flexure does this by providing a gimbal connection between the head slider and load beam. This type of gimbal connection can be provided in numerous ways such as by using a flexure that is formed separately from the load beam and then attached to the load beam or a flexure that is formed integrally with the load beam. According to one version of a three-piece head suspension construction, the flexure comprises a slider mounting tongue suspended by spring or gimbal arms. The slider is mounted to the tongue, thereby forming a head suspension assembly. The slider includes a read/write magnetic transducer or head provided on the slider and the slider is aerodynamically shaped to use the air bearing generated by a spinning disk to produce a lift force. During operation of such a disk drive, the gimbal arms permit the slider to pitch and roll about a load dimple or load point of the load beam, thereby allowing the slider to follow the plane of the disk surface.

In operation, a disk(s) of a disk drive rotates at high speeds, while a read/write head is positioned so that there is only a minimal air gap separation between the head and the disk surface. Providing a consistent air gap separation during operation of the disk drive is critical to assure accurate reading and storing of information on each disk. If the air gap is too large or if it varies during operation of the disk drive, critical information can be lost or misread by the head. Conversely, if the air gap is eliminated such that a read/write head can come into contact with an adjacent hard disk, permanent loss of data can occur along with damage to the head and disk that may be difficult or impossible to repair. In order to maintain the necessary air gap separation, it is thus important to properly adjust and maintain various parameters of each head suspension during their manufacture and assembly.

In relation to this, an important performance-related parameter of a head suspension is the orientation or attitude of the head slider as it flies over a disk surface. This orientation or attitude can be termed slider flying attitude and refers to the positional orientation of the head slider with respect to the surface of the disk when the head suspension is loaded, that is, under the influence of the balanced forces created by the spring force and the air bearing. When the head suspension is not actually flying over a spinning disk, this loaded state can be simulated. This can be done by applying a force in the same direction as the air bearing force at a point on the head suspension other than the head slider or, if the slider is not attached, a head slider bond pad where the head would be attached. This force is applied to lift the head slider to its loaded position or loaded state at fly height. The orientation or attitude of the head slider or slider bond pad under this simulated loaded state is referred to as its static attitude. Measuring static attitude can be easier than measuring slider flying attitude and static attitude can be correlated to slider flying attitude. As such, static attitude is often used as a performance parameter of a head suspension.

Because of the importance of correct slider flying attitude and the ability to correlate slider flying attitude to static attitude, various methods have been developed to obtain appropriate static attitude. Known adjust techniques cause a deformation or bending in a controlled manner of some portion of a head suspension to adjust static attitude. In one approach an apparatus that mechanically acts upon the load beam is used to manipulate, by twisting or bending, the load beam to adjust static attitude. In another approach, an apparatus that mechanically acts, in a similar manner, on a gimbal portion of a suspension is used. A more recently developed technique uses a laser to cause a controlled bend in some portion of a suspension to adjust static attitude. By controlling certain parameters of the laser radiation, a desired bend in the suspension can be achieved.

In a typical laser bending technique, a surface of the suspension is irradiated with a laser beam so that an area of the surface is quickly heated. If the material is only heated through a portion of its thickness, a temperature gradient between the front and back surfaces results. As cooling occurs, stresses form near the heated region and cause a permanent deformation in the suspension. This deformation can be used to adjust a performance parameter, such as static attitude, of a suspension.

One developed manner of irradiating a laser beam onto a suspension surface is to scan a laser beam across one or more surfaces of a suspension to adjust a performance parameter of the suspension. Scanning a beam along a predetermined path provides a temperature gradient between the front and back surfaces of the suspension along the scan path. As such, a permanent deformation can be introduced to the suspension along the scan path and a portion of the suspension can be deformed in a controlled manner to a greater extent as compared to heating an area of the suspension corresponding only to the spot size of the laser.

Known techniques for irradiating and scanning a laser beam across a surface of a suspension use a galvanometer based beam steering system to direct a laser beam along a desired path. High speed beam steering can be achieved by using mirrors mounted on computer controlled galvanometers that move the mirror(s) to direct the laser beam along the desired scan path. Such galvanometer based systems are known in the art and typically have the ability to steer a laser beam in two dimensions within a working field on a flat working surface. Because the beam is steered around within such a working field, these galvanometer based systems also use specially designed optics for focusing the beam. These focusing optics are known as F-Theta lenses and are designed to maintain the focus of a laser beam on a surface within a large working field. As such, the F-Theta lens is provided in a position stationary to the target working field and the beam is movable within the limits of the functional area of the F-Theta lens and thus within the target working field. The location of the focused spot on the working surface as focused by the F-Theta lens is proportional to the angle of the beam on the F-Theta lens. Thus, a longer focal length is required for such a lens to achieve a larger field size.

While such galvanometer based systems are effective for providing a laser beam that can be scanned along a predetermined path on a surface of a suspension for adjusting a performance parameter such as static attitude, several limitations exist. First, the working field of the focused beam is defined by the functional area of F-Theta lens. If a larger working field is desired, a lens having a larger functional focusing area must be used. Second, an F-Theta lens is designed to maintain the focus of a beam within predetermined limits of a predetermined plane such as the working field of a working surface. Thus, it is not possible to control the focus of the beam on the working surface with this type of beam steering system. For example, it may be desirable to over-focus or under-focus the beam in order to adjust the spot size of the beam. Third, the minimum spot that can be achieved for a laser beam focused by an F-Theta lens is larger than that which can be achieved with other focusing lenses.

### SUMMARY

The present invention provides apparatuses and methods for adjusting one or more performance parameters of a head suspension or head suspension assembly by using one or more laser adjust beams provided in a controlled directional manner. Generally, performance parameters such as static attitude, gram load, spring geometry, and load beam geometry, can be adjusted in accordance with the present invention.

In one aspect of the present invention an apparatus that scan a focused adjust beam across a surface of a suspension without using galvanometers and F-Theta lenses is provided. Generally, such an apparatus of the present invention includes a light source for providing an adjust beam and a focusing device for focusing the adjust beam. The adjust beam can be directed to the focusing lens along an optical path comprising any number of optical path defining elements. The apparatus is designed so that the focusing lens can be moved relative to the light source while maintaining the position of the adjust beam within the focusing lens. As such, the focusing lens and adjust beam can be moved relative to a surface of a suspension to scan the adjust beam across the surface of the suspension.

In another aspect of the present invention, the ability to deliver a laser adjust beam to different surfaces, such as oppositely facing surfaces, of a head suspension for adjusting a performance parameter in different adjust directions. For example, in one aspect of the present invention, an adjust beam can be delivered or directed to a surface of a predetermined portion of a head suspension along a first predetermined optical path to adjust a performance parameter in a first direction. The adjust beam can be delivered along a second predetermined optical path to another surface, such as an oppositely facing surface of the predetermined portion, to adjust the performance parameter in a second direction.

In another aspect, the present invention also provides adjust beams that have a small spot size as compared to those previously used for adjustment of performance parameters such as static attitude. As such, the present invention provides apparatuses and methods that facilitate the use of such small spot sizes to adjust such performance parameters. For a given material thickness and the same laser power density, a smaller spot size provides finer control over the magnitude of the stresses and increased adjust resolution. Thus, a small spot size, in accordance with the present invention, can provide increased precision and accuracy for adjusting performance parameters.

Accordingly, in one aspect of the present invention, a fiber laser and a gradient index focusing lens can be used to provide an adjust beam having a spot size that is significantly smaller than those previously used for laser adjust of performance parameters such as static attitude, for example. Moreover, in another aspect of the present invention, an apparatus can be provided that includes the ability to translate an adjust beam across a surface portion of a head suspension in order to adjust a performance parameter.

In another preferred aspect of the present invention, a method for directionally adjusting a performance parameter of a head suspension by impinging an adjust beam on first and second surfaces of the head suspension is provided. This method preferably comprises the steps of providing a light source, directing an adjust beam of the light source to impinge on a first surface of a head suspension by movably positioning an optical path defining element of a first optical path relative to the adjust beam. An adjust beam can be used to controllably heat a predetermined region of the head suspension for adjusting a performance parameter of the head suspension. By impinging an adjust beam on the first surface of the head suspension, the performance parameter of the head suspension can be adjusted in a first direction. In a similar manner, an adjust beam can be impinged on a second surface of the head suspension. By impinging an adjust beam on the second surface of the head suspension, the performance parameter of the head suspension can be adjusted in a second direction. That way, cooperative adjustment by plural beams in either the first or second directions can be used to adjust a performance parameter.

In yet another aspect of the present invention, a method for adjusting a performance parameter of a head suspension with a laser adjust beam that has a small spot size is provided. The method includes impinging a laser adjust beam on a surface of a portion of the head suspension wherein the laser adjust beam has a spot size that is less than the thickness of the portion of the head suspension. The laser adjust beam controllably heats a predetermined region of the surface of the portion of the head suspension with the laser adjust beam for adjusting a performance parameter of the head suspension.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a head suspension assembly to which the present invention is applicable, the head suspension assembly comprises a baseplate, a load beam, a flexure, and a slider mounted to the flexure at a distal end thereof;

FIG. 2 is a top view of an exemplary gimbal region of a flexure and a load beam tip portion that can be used in a head suspension and showing in particular a pair of gimbal arms connected to a slider mounting tongue having a slider mounted thereto;

FIG. 3 is a side view of a head suspension assembly shown in an unloaded state wherein a rigid region of the load beam is at an angle Θ with respect to the baseplate as defined by a spring region of the load beam;

FIG. 4 is a partial side view of a head suspension assembly shown positioned relative to a disk of a dynamic storage device and showing in particular the slider of the head suspension assembly flying with respect to the disk in the typical operating position;

FIG. 5 is a side view of a head suspension assembly shown with a load applied to the load beam for simulating an operating state of the load beam and illustrating a pitch static attitude of the slider of the head suspension assembly as positioned by the loaded load beam;

FIG. 6 is a side view of a head suspension assembly shown with a load applied to the load beam for simulating an operating state of the load beam and illustrating a roll static attitude of the slider of the head suspension assembly as positioned by the loaded load beam;

FIG. 7 is a perspective view of an apparatus in accordance with the present invention for determining and adjusting the static attitude of a head suspension or a head suspension assembly showing a front side of the apparatus and showing in particular an autocollimator and a tool head having a working region;

FIG. 8 is another perspective view of the apparatus of FIG. 7 showing a rear side of the apparatus;

FIG. 9 is a perspective view of the apparatus of FIGS. 7 and 8 showing the apparatus with the autocollimator and a supporting structure for the autocollimator removed from the apparatus;

FIG. 10 is a perspective view of the tool head of the apparatus of FIGS. 7-9 showing in particular an objective mount having a plurality of mirrors provided thereon and that is movably attached to a mounting plate of the tool head;

FIG. 11 is another perspective view of the tool head of FIG. 10, which illustrates the tool head from a different direction than that of FIG. 10;

FIG. 12 is an exploded perspective view of the mounting plate of the tool head of FIGS. 10 and 11 showing in particular first and second posts that can be used to adjustably position first and second mirrors, respectively, with respect to the mounting plate;

FIG. 13 is a perspective view of the objective mount of the tool head of FIGS. 10 and 11 shown with the mirrors removed and showing in particular a plurality of windows that allow an adjust beam to pass through the objective mount;

FIG. 14 is a schematic view of a first optical path of the apparatus of FIG. 1 along which an adjust beam from a laser can be directed to a first surface of a component positioned with respect to the working region of the tool head of the apparatus; and

FIG. 15 is a schematic view of a second optical path of the apparatus of FIG. 1 along which an adjust beam from a laser can be directed to a second surface of a component positioned with respect to the working region of the tool head of the apparatus.

### DETAILED DESCRIPTION

Dynamic data storage devices, such as magnetic or optical storage drives are well known in the industry and typically include rigid or floppy disks. Rigid magnetic drives, for example, use a rigid disk coated with a magnetizable medium for storage of digital information in a plurality of circular, concentric data tracks. The disk is usually mounted on a motorized spindle which spins the disk and causes the top and/or bottom surfaces of the disk to pass under respective read/write heads. A typical head includes a hydrodynamically designed air bearing slider and a transducer for writing information to and/or reading information from the disk surface. An actuator mechanism moves the heads from track to track across the surfaces of the disk under control of electronic circuitry. The actuator mechanism typically includes an arm, or e-block and each arm is then connected with one or more head suspension assemblies.

Head suspension assemblies, also sometimes known as head gimbal assemblies, are commonly used in rigid disk drives to support the heads in close proximity to the rotating disk surfaces. Typically, such head suspension assemblies provide a preload bias that forces the read/write heads toward a disk surfaces to counteract an aerodynamic lift force that acts in an opposite direction as the head flies on a generated air bearing above the rotating disk surface. The force of such bias is often referred to as the gram load and can be adjusted by controlling the shape and geometry of a spring section of the head suspension.

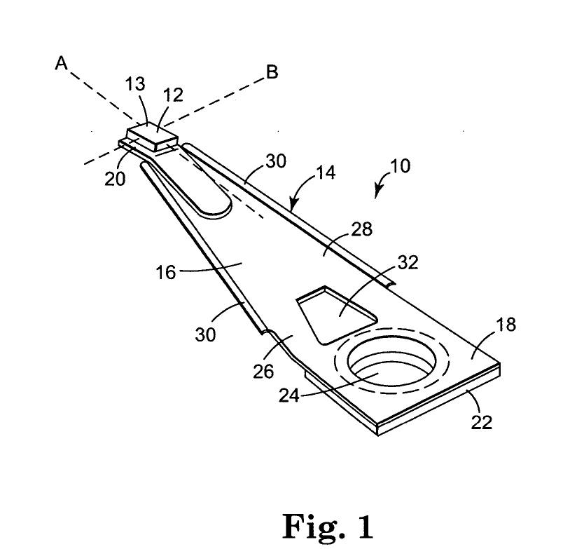

One such exemplary head suspension assembly 10 is illustrated in FIG. 1. As shown, the head suspension assembly 10 includes a head slider 12 mounted to a head suspension 14. The head suspension 14 includes a load beam 16, mounting region 18, and gimbal or flexure 20. The gimbal or flexure 20 is provided at a distal end of the load beam 16 and the mounting region 18 is provided at a proximal end of the load beam 16.

When incorporated into a disk drive, the mounting region 18 of the load beam 16 can be mounted to an actuator or positioning arm (not shown) which supports the head suspension assembly 10 over a rotating disk. A baseplate 22, which usually includes a mounting hole 24, is typically welded to the mounting region 18 to increase the rigidity of the mounting region and to provide a mechanism for securely mounting the head suspension assembly 10 to the positioning arm.

The load beam 16 is an elongated and often generally triangularly-shaped member, which includes a spring section 26 adjacent to the mounting region 28 for creating the preload bias, and a rigid section 28, which extends from the spring section 26. Typically, the rigid section 18 includes stiffening features 30, such as rails, that extend along at least a portion of the sides of the rigid section 28 for transferring the preload bias to the flexure 20 and thus slider 12.

The spring section 26 of the head suspension assembly 10 shown in FIG. 1 includes a central opening 32 which forms the spring section 26 into two legs as shown. In this embodiment, the flexure 20 is provided as a separate member, and attached to the distal end of the rigid region 28 by welding or other suitable technique. However, the flexure 20 may be formed integrally with the distal end of the rigid region 28 of the more rigid load beam 16 as are well known.

The head slider 12 contains a head (not shown) for reading and/or writing data, has an air bearing surface 13, and is typically bonded to the flexure 20 by adhesive or the like. The air bearing surface is aerodynamically designed to ride on an air bearing created above a spinning disk so that the head can fly with respect to the spinning disk. The spring force thus counteracts to balance and define the “flying height” of the head slider as described in more detail below.

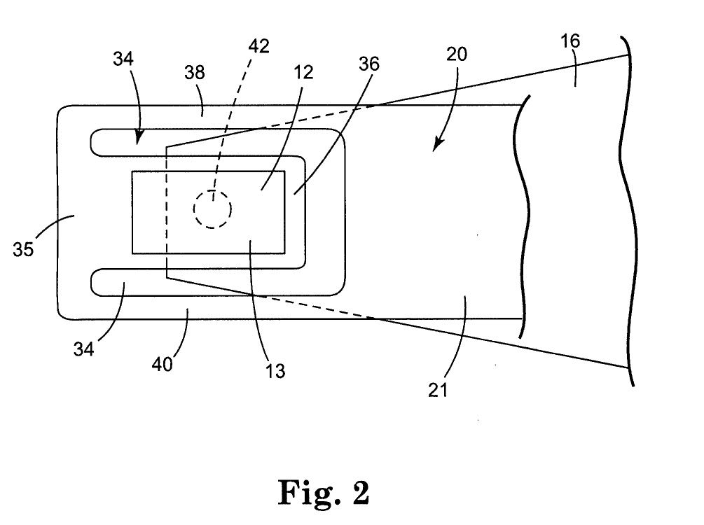

In FIG. 2, a partial top view of the distal end of the head suspension assembly 10 of FIG. 1 is shown. A mounting portion 21 of the flexure 20 is attached to the distal end of the load beam 16 by welding or other suitable technique. As such, other portions of the flexure 20 extending from the mounting portion 21 can generally flex away from the load beam 16. The flexure 20 has a cutout 34, which in the illustrated embodiment is generally U-shaped. The cutout 34 defines a slider mounting tongue 36 for mounting the slider 12 thereon. The cutout 34 also defines a first gimbal arm 38 and a second gimbal arm 40. The first and second gimbal arms, 38 and 40, are each attached to the slider mounting tongue 36 by a crossbar portion 35 and each extend distally from the mounting portion 21. The load beam 16 also has a load point dimple 42 that engages with a back surface of the slider mounting tongue 36. The load point dimple 42 is typically a stamped feature on the load beam 16 (or the gimbal 20) having an apex that contacts the under surface of the tongue 36 where the dimple 42 is formed on the load beam 16. The load point dimple 42 functions to provide a pivot point as further described below with respect to FIG. 4. Alternatively, such a load point dimple 42 could extend from the slider mounting tongue 36 to engage a distal portion of the load beam 16.

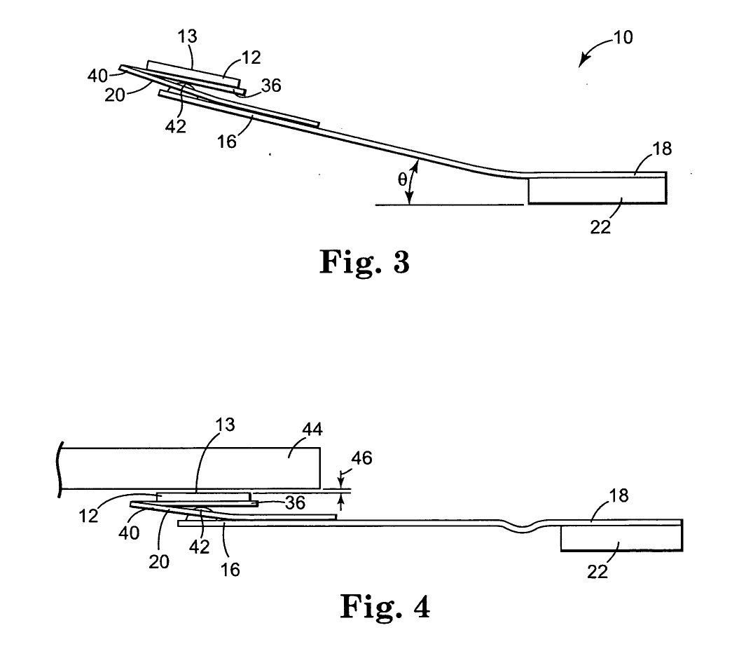

In FIG. 3, the head suspension assembly 10 is schematically shown in an unloaded or free state. Generally, in the unloaded state the back surface of the tongue 36 rests against the apex of the load point dimple 42 under the spring action of the gimbal arms 38 and 40. This spring action results as the gimbal arms, 38 and 40, are flexed by the height of the load point dimple 42.

As can be seen in FIG. 3, the load beam 16 is at an angle θ relative to the baseplate 22. The bend of the spring region 26 provides a preload bias to urge the slider 12 toward the disk in operation. In the unloaded state of the head suspension assembly 10, as shown in FIG. 3, no preload is present since the head suspension assembly is not flexed from its unloaded state (i.e. is not loaded). Generally, as the load beam 16 is forced in a direction such that the angle θ is reduced, a preload bias is generated acting in the opposite direction.

Referring to FIG. 4, the head suspension assembly 10 is shown in use with a rotating hard disk 44. As mentioned above, the head suspension assembly 10 provides a preload bias to the slider 12 to urge the slider 12 toward a surface of the disk 44. As the disk 44 rotates, the disk 44 drags air and creates an air bearing under the slider 12 along the air bearing surface 13 of the slider 12 in a direction approximately parallel to the tangential velocity of the disk 44. As the air passes beneath the slider 12, friction on the aerodynamically designed air bearing surface 13 causes the air pressure between the disk 44 and the air bearing surface 13 to increase, which creates a hydrodynamic lifting force that causes the slider 12 to lift and fly above the surface of the disk 44. The preload bias supplied by the spring region 26 of the load beam 16 counter-balances with the hydrodynamic lifting force to define a desired fly height.

The preload bias and the hydrodynamic lifting force reach equilibrium based upon the hydrodynamic properties of the slider 12 and the speed of rotation of the disk 44. The preload bias is transferred from the load beam 16 to the slider 12 through the load point dimple 42. Accordingly, the load point dimple 42 provides a point about which the slider 12 can pitch and roll and it limits vertical displacement of the slider 12 and flexure 20 in a direction away from the disk surface. The rotation of the disk 44 causes the slider 12 to be positioned a distance 46 from the surface of the disk 44. The distance 46 is referred to as the slider “flying height” and represents the position that the slider 12 occupies when the disk 44 is rotating during normal operation. It is desirable to maintain the flying height 46 within a limited range in order to ensure high quality of the data read from or written to the disk 44.

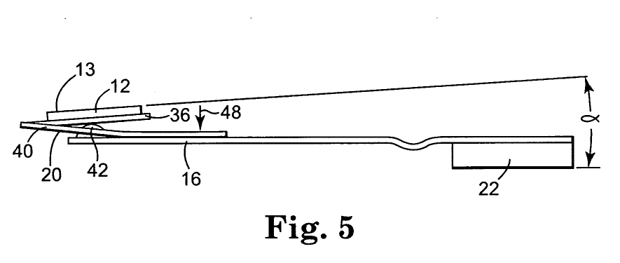

Static attitude includes a pitch component and a roll component. In FIG. 5, the load beam 16 is schematically shown held in a loaded state by an external means such as a force indicated generally by arrow 48. Here, the angle θ is reduced from the unloaded state and the preload bias from spring section 26 acts in the direction opposite that of arrow 48. Such loading simulates the configuration of the load beam 16 during operation. The angle α is referred to as the pitch static attitude and generally defines a pitch aspect of the planar orientation of a surface of the slider 12 as taken about the pitch axis B shown in FIG. 1. In this configuration, a representative surface portion of the air bearing surface 13 and the bottom surface of the baseplate 22 define the angle α. It is understood that the angle α may also be measured between any two surfaces that represent a planar orientation of a surface of the slider 12 including a surface of the flexure 20, a surface of the slider mounting tongue 36, or from any other datum chosen along the head suspension.

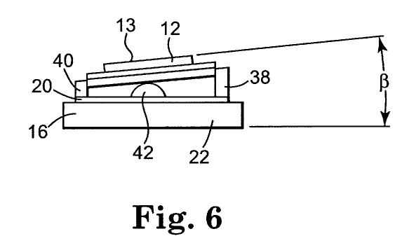

Shown in FIG. 6 is a schematic end view of the head suspension assembly 10 of FIG. 5 with the load beam 16 held in the loaded state as was described with respect to FIG. 5. The illustrated angle β is referred to as the roll static attitude and generally defines a roll aspect of the planar orientation of a surface of the slider 12 as taken about the roll axis A shown in FIG. 1. The angle β is defined by the horizontal tilt of the representative air bearing surface 13 relative to the bottom surface of the baseplate 22 as is illustrated in FIG. 6. It is understood that this angle β may also be measured between any surfaces the represent a planar orientation of a surface of the slider 12.

While static attitude and gram load are considered to be critical performance parameters, another critical performance parameter of a suspension relates to its resonance characteristics. In order for the head slider to be accurately positioned with respect to a desired track on the magnetic disk, the head suspension should be capable of precisely translating or transferring the motion of the positioning actuator arm to the slider. An inherent property of moving mechanical systems, however, is their tendency to bend and twist in a number of different modes when subject to movements or vibrations at certain rates known as resonant frequencies. At resonant frequencies that may be experienced during disk drive usage, the movement of a distal tip of the head suspension assembly, or its gain, is at is maximum, so such gain is preferably minimized by the construction of the head suspension assembly. Any bending or twisting of a head suspension can cause the position of the head slider to deviate from its intended position with respect to the desired track, particularly at such resonant frequencies. Because the disks and head suspension assemblies are driven at high rates of speed in high performance disk drives, the resonant frequencies of a head suspension should be as high as possible. Resonance characteristics are usually controlled by precision construction, design and manufacture of the load beam. Accordingly, any changes or deformation to a head suspension may adversely affect the resonant characteristics of the head suspension assembly. In order to control such resonance characteristics it may be necessary to adjust the shape and/or geometry of certain portions of the head suspension assembly such as the load beam and spring region, for example.

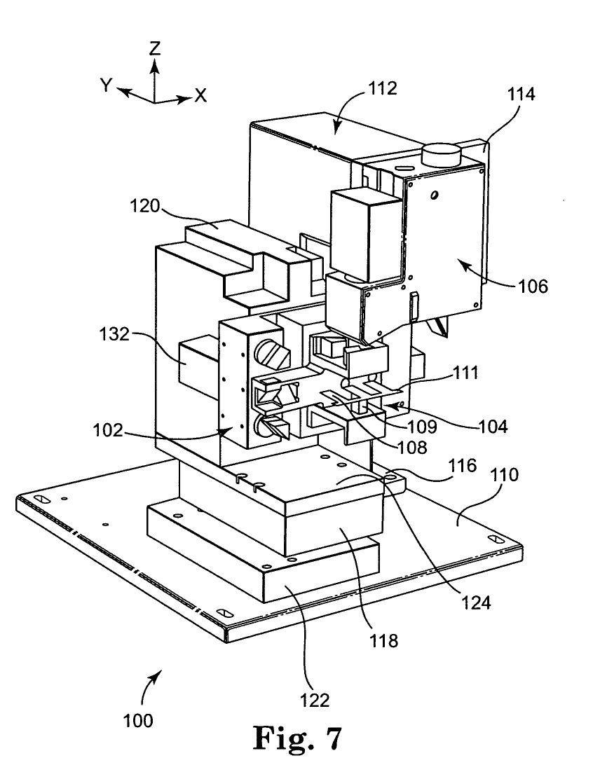

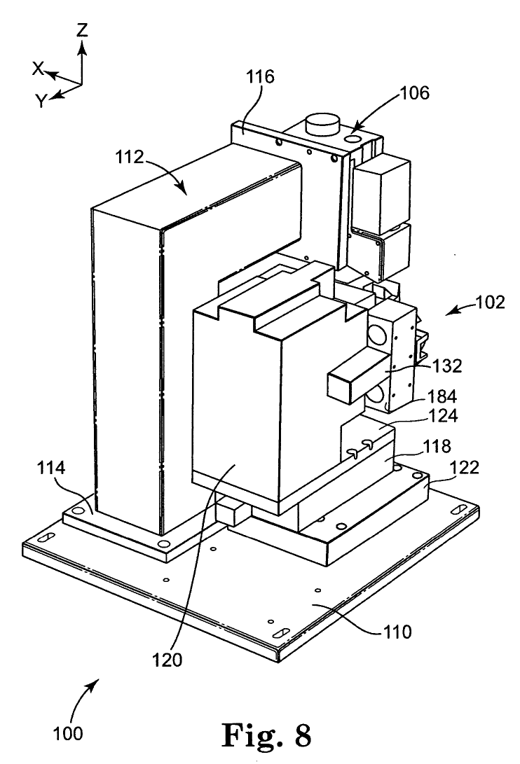

With reference to FIGS. 7 and 8, an apparatus in accordance with an aspect of the present invention for determining and adjusting a performance parameter such as static attitude, gram load, spring geometry, and load beam geometry of a head suspension or a head suspension assembly is shown and identified generally by reference numeral 100. For the purposes of explaining the functional aspects of the present invention, static attitude is used as an example of a performance parameter that can be adjusted in accordance with apparatuses and methods of the present invention. However, it is noted that any performance parameter(s) related to the shape, relative position, and/or angular orientation of any portion of a head suspension or head suspension assembly can be adjusted in accordance with the present invention.

The apparatus 100 can be used to measure and adjust either or both roll static attitude and pitch static attitude of a head suspension or head suspension assembly during manufacture or assembly of such suspensions, for example. As shown, the apparatus 100 generally includes a tool head 102 and an autocollimator 106 for measuring a surface orientation such as static attitude and may include any other measurement and/or characterization devices for measuring any desired performance parameters. The tool head 102 preferably includes a working region 104 that can receive a component to be measured and/or adjusted. For example, an exemplary component 108 is schematically shown positioned in the working region 104 of the tool head 102 as provided by a carrier strip 111 supported by a workpiece holder 109 that is schematically shown and described in more detail below.

In accordance with preferred uses of the present invention, the component 108 is a head suspension or a head suspension assembly such as the exemplary head suspension assembly 10 described above with respect to FIGS. 1-6. However, any head suspension or head suspension assembly or similar component having one or more surfaces provided at a controlled angle or orientation as provided in any position such as by a workpiece holder can be adjusted in accordance with the present invention.

As illustrated, the apparatus 100 includes a baseplate 110. The tool head 102 and the autocollimator 106 are preferably operatively positioned with respect to the baseplate 110. The autocollimator 106 is preferably supported and positioned with respect to the baseplate 110 by an arm 112 so that the autocollimator 106 is positioned in a fixed position with respect to the baseplate 110. As shown in FIG. 8, the arm 112 is attached to the baseplate 110 at a first end 114 of the arm 112 and the autocollimator 106 is attached to the arm 112 at a second end 116 of the arm 112. As such, the autocollimator 106 can be stationary and in a known position with respect to the baseplate 110 and thus to any part maintained in a known position. By providing the autocollimator 106 in a fixed position with respect to the baseplate 110, a generally simpler apparatus with fewer moving parts can be provided. However, it is contemplated that the autocollimator 106 may be movably positionable with respect to the baseplate 110 or any other portion of the apparatus 100 in any desired manner and in any desired direction as controllable x-y or x-y-z positioning mechanisms are well known.

Preferably, the autocollimator 106 comprises a measurement device that is capable of measuring an angular orientation such as the static attitude of a surface of the component 108. Generally, the autocollimator 106 provides a light beam that can be used to determine the angular orientation of such a surface with respect to a predetermined frame of reference. The light beam is directed to impinge upon the surface so that a detector can sense a reflected portion of the light beam. Information such as the position of the reflected beam on the detector can then be used to determine the angular orientation of the surface, which can be used to determine static attitude of the surface. Exemplary autocollimators that can be used in accordance with the present invention are the subject of currently co-pending and co-assigned U.S. patent application Ser. No. 10/138,728, filed May 3, 2002, and entitled “Static Attitude Determination and Adjust of Head Suspension Components,” the entire disclosure of which is incorporated fully within this application by reference for all purposes. Although autocollimator based devices are preferred, any measurement device, probe, or instrument whether utilizing optical, electrical, or mechanical means and that is capable of determining the static attitude or angular orientation of a surface in accordance with the present invention can be used.

The tool head 102 can be used to deliver a laser adjust beam to a surface of the component 108 for adjusting the static attitude of the component 108 as based on a measured static attitude and a predetermined desired static attitude. However, it is noted that static attitude can be adjusted as based on any information, however attained, and/or static attitude can be adjusted without first measuring static attitude with any device such as the autocollimator 106. Moreover, static attitude can be measured in an unloaded or loaded state of a head suspension or head suspension assembly as described above with respect to FIG. 3 and FIG. 5, respectively. Advantageously, in accordance with the present invention, a laser adjust beam can be selectively or cooperatively delivered to different surfaces of the component 108. For example, where the component 108 is a head suspension assembly, an adjust beam can be delivered to oppositely facing surfaces of a gimbal portion of the component 108.

With respect to the tool head 102, the apparatus 100 is preferably designed so that the tool head 102 is movably positionable with respect to the baseplate 110 in one or more directions. As such, the working region 104 of the tool head 102 can be positioned and moved with respect to the component 108 for providing an adjust beam to a surface of the component 108 as described in more detail below.

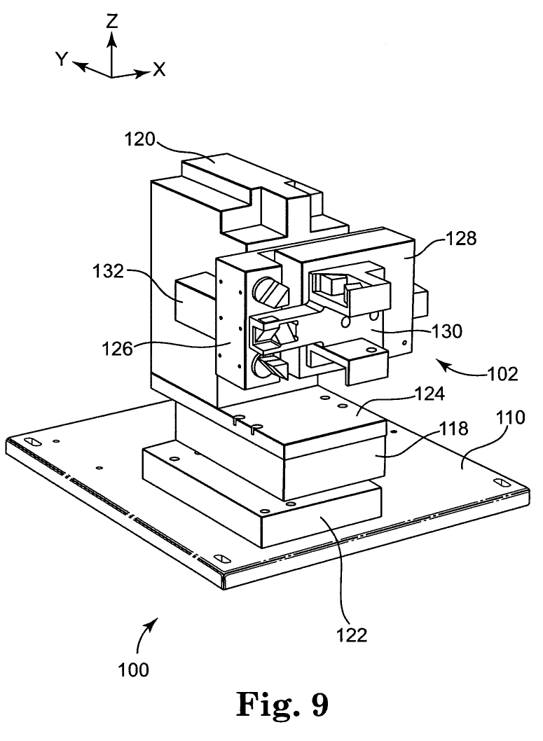

In one aspect of the present invention, the ability to scan an adjust beam along a predetermined path and controllably focus the beam on a surface of the component 108 by moving the tool head 102 is provided. Thus, the apparatus 100 preferably includes movable stages 118 and 120 and movable stage 128 (see FIG. 9 and description below) for positioning the tool head 102 with respect to the baseplate 110. The movable stage 118 can provide Y-axis motion, the movable stage 120 can provide Z-axis motion, and the movable stage 128 can provide X-axis motion as described in more detail below.

Such moveable stages typically include a first portion that is movably provided with respect to a second portion of the moveable stage such as by using bearings, shafts, lead screws, and the like as are conventionally known. Generally, the first and second portions are drivable with respect to each other such as by using a motor or the like. Such driving of the movable stage can be controlled by using a control system as mentioned below. The first portion of such a moveable stage can be attached to the tool head 102 and the second portion of the moveable stage can be attached to the baseplate 110 so that the tool head 102 and the baseplate 110 can be controllably moved with respect to each other by driving one portion of the moveable stage relative to the other.

As shown, the movable stage 118 is mounted to the baseplate 110 by an adapter plate 122 and the movable stage 120 is mounted to the movable stage 118 by an adapter plate 124. The tool head 102 is preferably mounted to the movable stage 120, as shown. The adapter plates 122 and 124 make it easier to assemble the moveable stages 118 and 120 with respect to each other and with respect to the tool head 102 and the baseplate 110. However, the moveable stage 118 could be mounted directly to the baseplate 110 without using the adapter plate 122, if desired. Similarly, the movable stage 120 could be mounted directly to the moveable stage 118 without using the adapter plate 124, if desired. Preferably, the movable stage 118 is capable of providing motion to the tool head 102 in the y-axis. In any case, any type of mechanism or device can be used to provide any desired relative motion between the tool head 102 and a component, such as component 108, positioned with respect to the working region 104 of the tool head 102 including moving the component 108. Also, the apparatus 100 preferably includes a control system (not shown) for controlling the motion of the movable stages 118, 120, and 128 (controlling the driving of motors on movable stages, for example). The control system can be used to control other aspects of the apparatus 100 such as those related to control aspects of measurement and adjust processes as described below.

Because the autocollimator 106 of the exemplary apparatus 100 is preferably in a fixed position with respect to the baseplate 110, the workpiece holder 109 can be capable of positioning the component 108 in a measurement position with respect to the autocollimator 106. However, as noted above, the autocollimator 106 can be movable in order to perform a measurement on the component 108. A measurement position generally refers to a position where a desired surface of the component 108 is positioned with respect to the autocollimator 106 so that the autocollimator 106 can determine the angular or planar orientation of such surface. For example, a measurement position may be the location of the focal point of a measurement beam of the autocollimator 106.

After a measurement has been made with the autocollimator 106, the movable stages 118, 120, and 128 are preferably used to position the working region 104 of the tool head 102 with respect to the component 108 (while still positioned in the measurement position) so that a laser adjust beam can be delivered to the component 108 for adjusting a performance parameter such as static attitude as described in greater detail below.

The component 108 can be provided to the working region 104 of the tool head 102 in any manner. Preferably, the apparatus 100 is integrated into a manufacturing line or system. As such, the workpiece holder 109 can comprise any mechanisms or devices that are capable of controllably positioning the component 108 in a measurement position with respect to the autocollimator 106. For example, the workpiece holder 109 may include clamping and/or fixturing devices. Preferably, in the exemplary apparatus 100, the autocollimator 106 remains stationary, as shown, and the component 108 is moved into the measurement position with respect to the autocollimator 106.

For example, the apparatus 100 can be used as a station of a head suspension assembly manufacturing system. In some systems currently in use for manufacturing head suspensions, suspensions are provided on a carrier strip (such as the carrier strip 111 illustrated in FIG. 1) and are moved from station to station by advancing the carrier strip in a processing direction. Accordingly, the apparatus 100 can be integrated with such a system so that the working region 104 can receive a head suspension or head suspension assembly carried by a carrier strip and can be used to measure and adjust static attitude in accordance with the invention. Also, head suspensions or head suspension assemblies can be provided to the working region 104 individually (not as part of a carrier strip) by using a fixture, carrier, or tray that can be presented to the working region such as by using an automated device or mechanism.

With reference to FIG. 9, the apparatus 100 is shown with the arm 112 and the autocollimator 106 removed. Generally, the tool head 102 comprises a mounting plate 126, a movable stage 128, an objective mount 130, and a laser 132. As shown, the mounting plate 126 is mounted to the movable stage 120, the movable stage 128 is mounted to the mounting plate 126, and the objective mount 130 is mounted to the movable stage 128. Preferably, the movable stage 128 is movable along the x-axis and can translate the objective mount 130 along the x-axis with respect to the mounting plate 126. The moveable stage 128 can also be controlled by a control system as described above. By moving the objective mount 130 along the x-axis, a laser adjust beam can be selectively provided to the working region 104 from different directions. Also, moving the objective mount 130 along the x-axis can also be used to scan an adjust beam across a surface of the component 108 when the component 108 is positioned in the working region 104. This can be particularly useful where it is desired to keep the component 108 stationary while performing an adjust operation. This motion, along with motion that can be provided in the y-axis by the movable stage 118, can be used to scan an adjust beam across a selected surface of the component 108 along any desired path. In one aspect of the present invention, moving the objective mount 130 also provides the ability to move an adjust beam together with a focusing lens to scan the adjust beam across a surface of the component 108 rather than steering the adjust beam within a stationary focusing lens/device to provide such scanning of an adjust beam. Moreover, as described below, the movable stage 120 can be used to control the focus of an adjust beam on a surface of the component 108.

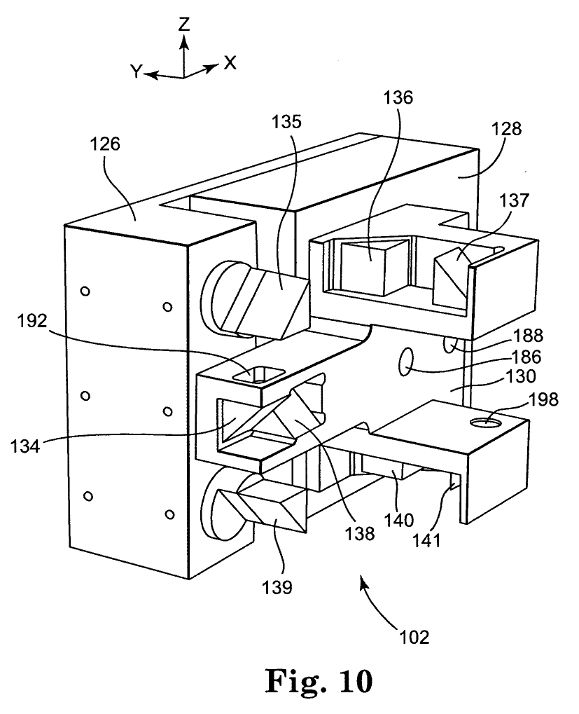

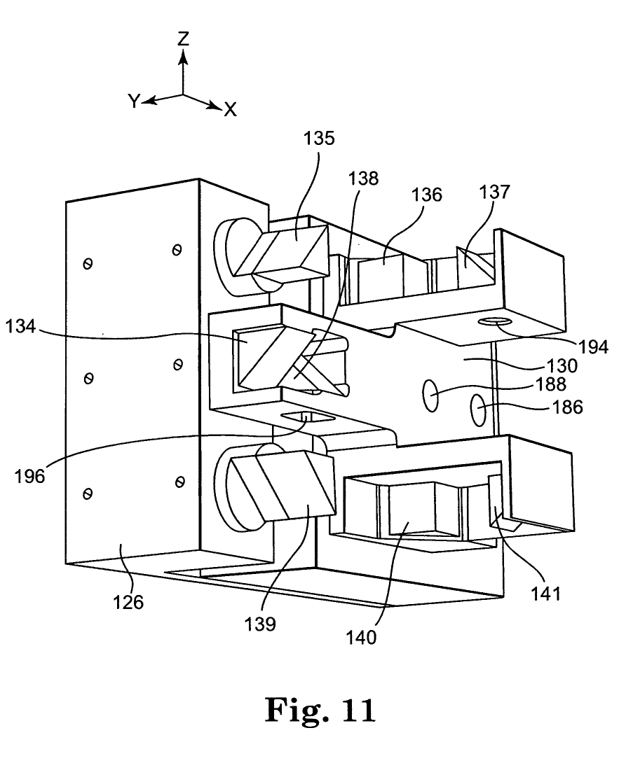

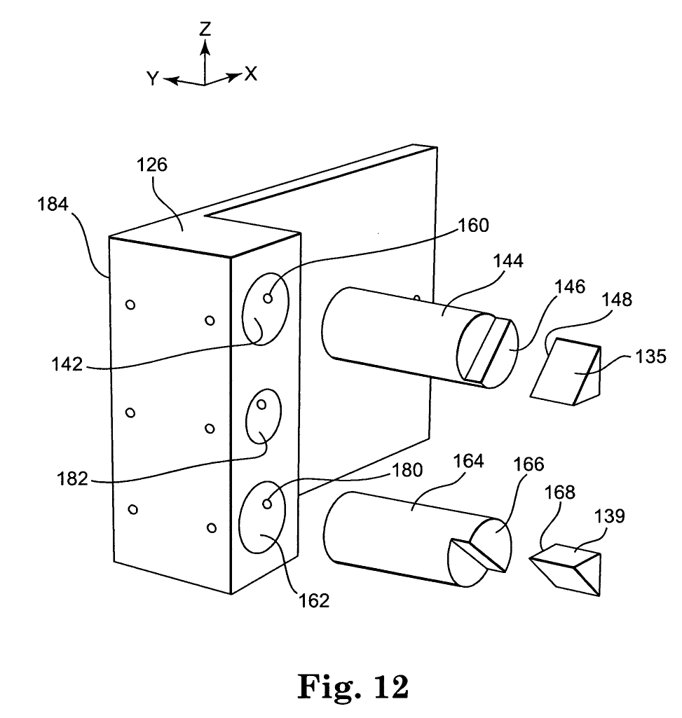

As can best be seen in FIGS. 10 and 11, the tool head 102 also preferably includes mirrors 134, 135, 136, 137, 138, 139, 140, and 141. As described in more detail below, mirrors 134, 135, 136, and 137 are arranged to provide a first optical path and mirrors 138, 139, 140, and 141 are arranged to provide a second optical path. Generally, the first optical path can provide an adjust beam to the working region 104 in a first direction and the second optical path can provide an adjust beam to the working region 104 in a second direction. In a preferred embodiment of the present invention, the first and second directions are opposite directions. As shown, the mirrors 135 and 139 are mounted to the mounting plate 126 and the mirrors 134, 136, 137, 138, 140, and 141 are mounted to the objective mount 130. An exemplary manner by which the mirrors 138, 139, 140, and 141 can be mounted is provided below. Any mirrors, reflective surfaces, or devices that are capable of functionally directing a beam of light in a controlled manner along a predetermined path in accordance with the present invention can be used. Such mirrors typically include one or more attachment surfaces for attaching or holding a mirror with respect to a mounting structure or the like and one or more light reflective surfaces that can be positioned at a desired angle with respect to another reflective surface(s) and/or light beam to be reflected. Mirrors for reflecting laser light in a controllable manner are well known in the art and are commercially available.

With reference to FIG. 12, an exploded view of the mounting plate 126 is shown, which illustrates how the mirrors 135 and 139 can be mounted to the mounting plate 126. Preferably, the mirrors 135 and 139 are adjustable (for setup of the optical paths, for example) and can be rotated on an axis that extends in the y-axis as shown and as is described in more detail below. Also, the mirrors 135 and 139 are preferably adjustable in a linear manner (along the y-axis) as described below. As shown, the mounting plate 126 includes a bore 142 that can slidingly receive a post 144 that includes a mounting surface 146. Preferably, a surface 148 of the mirror 135 can be attached to the mounting surface 146 of the post 144. For example, a suitable adhesive such as CONAP EASYPOXY V, available from Cytec of Olean, N.Y. can be used to glue surface 148 of the mirror 135 to the mounting surface 146. Preferably, the post 144 can rotate within the bore 142 and translate with respect to the bore 142 (along the y-axis) in order to adjust the orientation of the mirror 135 with respect to the mounting plate 126. A set screw (not shown) is preferably provided in a tapped hole 160 for holding the post 144 within the bore 142 both rotationally and translationally.

Also, with respect to the mirror 139 the mounting plate 126 preferably includes a bore 162 that can slidingly receive a post 164. As shown, the post 164 preferably includes a mounting surface 166. Preferably, a surface 168 of the mirror 139 can be attached to the mounting surface 166 of the post 164 as described above, for example. Like the post 144, the post 164 can preferably rotate within the bore 162 and translate with respect to the bore 162 (along the y-axis) in order to adjust the orientation of the mirror 139 with respect to the mounting plate 126. Also a set screw (not shown) is preferably provided in a tapped hole 180 for the post 164 within the bore 162.

Further referring to FIG. 12, the mounting plate 126 also preferably includes a bore 182. Preferably, the bore 182 is provided so that a light beam from the laser 132 can pass through the bore 182 and impinge upon one of the mirrors 134 and 138 as described below. Preferably, the laser 132 is mounted to a surface 184 of the mounting plate 126 (see FIG. 8, for example) so that a light beam from the laser can pass through the bore 182 in the mounting plate 126.

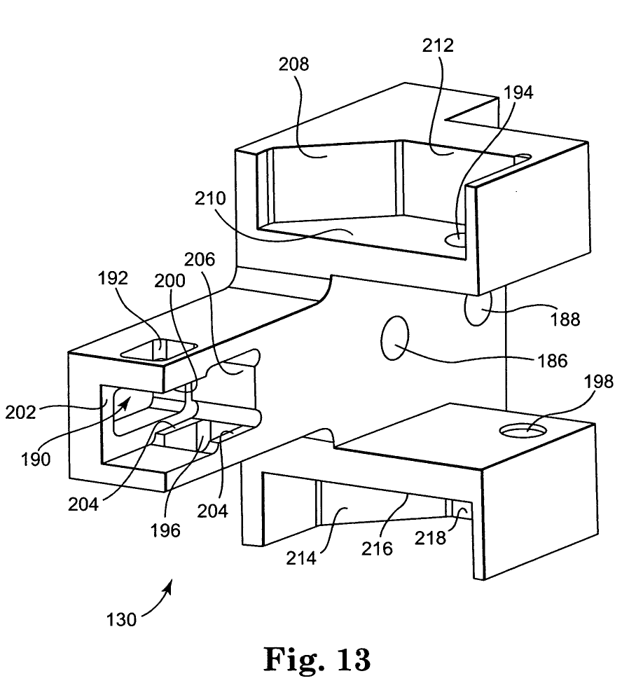

Referring to FIG. 13, the objective mount 130 is illustrated with the mirrors 134, 136, 137, 138, 140, and 141 removed. As described above, such mirrors typically include attachment surfaces and light reflecting surfaces. As such, the objective mount 130 is preferably designed to have mounting surfaces to which predetermined attachment surfaces of the mirrors 134, 136, 137, 138, 140, and 141 can be functionally attached such as by using an adhesive, mechanical securment, or the like. Such mounting surfaces, are preferably designed to provide a desired positional relationship between a reflective surface of each of the mirrors 134, 136, and 137 with respect to a reflective surface of the mirror 135 for providing a first optical path and the mirrors 138, 140, and 141 with respect to the mirror 139 for providing a second optical path. Accordingly, the objective mount 130 includes mounting surfaces 200 and 202 that can be used to mount mirror 134 and surfaces 204 and 206 that can be used to mount mirror 138. Also, surfaces 208 and 210 are provided for mounting the mirror 136 and a surface 212 along with surface 210 can be used to mount the mirror 137. Similarly, surfaces 214 and 216 are provided for mounting the mirror 140 and a surface 218 along with the surface 216 can be used to mount the mirror 141. While the exemplary objective mount 130 uses mirrors attached to mounting surfaces of the objective mount 130 to form optical paths in accordance with the present invention, it is contemplated that such optical paths can be provided by using any optical components and/or structure as would be apparent to those skilled in the art. As mentioned above, any devices capable of functionally redirecting light along a predetermined path may be used for defining one or more optical paths. Moreover it is contemplated that plural objective mounts may be used. That is, a first optical path can be provided by a first objective mount and a second optical path can be provided by a second objective mount either or both of which can be selectively movable. In any case, any number of optical paths can be provided by any number of objective mounts in accordance with the present invention.

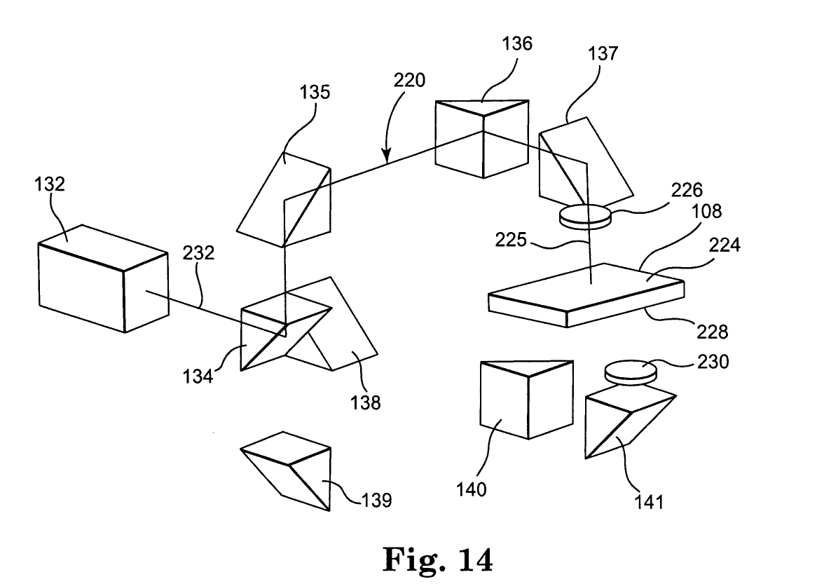

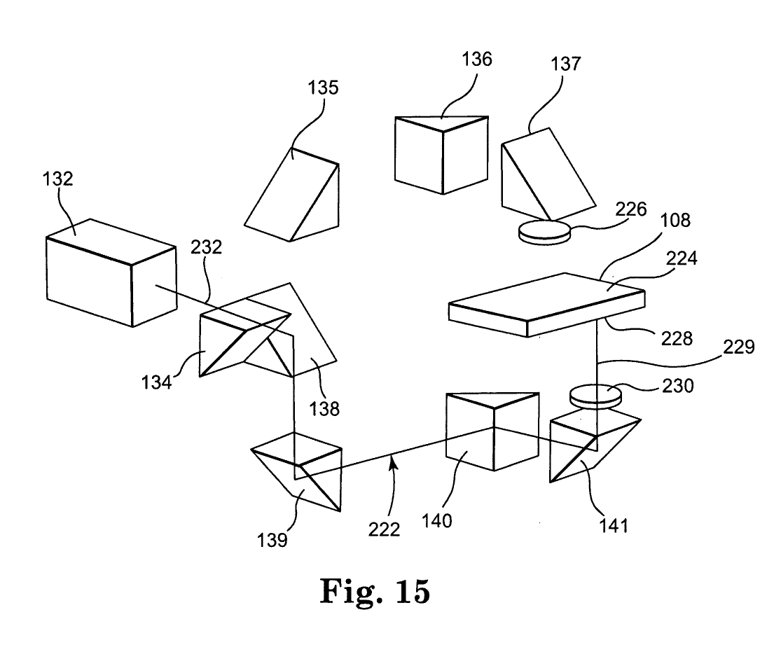

Referring to FIG. 13 along with FIGS. 10 and 11, the objective mount 130 includes bores 186 and 188 that can be used to attach the objective mount 130 to the movable stage 128 via suitable fastener such as screws or bolts or the like. The objective mount 130 also preferably includes a window 190 that allows a light beam from the laser 132 to selectively impinge upon one of the mirrors 134 and 138 as described below. Preferably, when the objective mount 130 is attached to the movable stage 128, the window 190 is aligned with the bore 182 of the mounting plate 126. The objective mount 130 also preferably includes a window 192 that allows light that is reflected by mirror 134 to be directed to mirror 135 and a window 194 that allows light that is reflected by mirror 137 to be directed into the working region 104. Preferably, the window 194 includes a focusing lens 226, operatively positioned with respect to the window 194 and the mirror 137, (not visible in FIG. 13 but see FIG. 14 and the description below) for receiving and focusing an adjust beam in accordance with the invention. For example, the window 194 may be formed as a counterbore and the focusing lens 226 may be positioned and secured in the counterbore. Also, the objective mount 130 preferably includes a window 196 that allows light that is reflected by mirror 138 to be directed to mirror 139 and a window 198 that allows light that is reflected by mirror 141 to be directed into the working region 104. The window 198 also preferably includes a focusing lens 230, operatively positioned with respect to the window 198 and the mirror 141 (see FIG. 15 and the description below) for receiving and focusing an adjust beam in accordance with the invention.

Referring to FIGS. 14 and 15 an optical system 105 of the apparatus 100 is schematically illustrated. Generally, the optical system 105 includes the laser 132, the mirrors 134, 135, 136, 137, 138, 139, 140, and 141, and the focusing lenses 226 and 230. In one preferred embodiment, a fiber laser, mirrors, and gradient index focusing lenses, as conventionally known, may be used as components of the optical system 105 in accordance with the present invention.

Referring to FIG. 14, a first optical path 220 is illustrated that is defined by mirrors 134, 135, 136, and 137 and in FIG. 15 a second optical path 222 is illustrated that is defined by mirrors 138, 139, 140, and 141. The optical paths 220 and 222 may be provided by the objective mount 130 as described above or the optical paths 220 and 222 may be provided on independent objective mounts. As illustrated, the optical path 220 provides a path from the laser 132 all the way to a first surface 224 of the component 108 for an adjust beam 225. Preferably, the focusing lens 226 is provided between the mirror 137 and the first surface 224 of the component 108. For example, the focusing lens 226 may be positioned in the window 194 of the objective mount 130 as described above. Similarly, the optical path 222 provides a path from the laser 132 all the way to a second surface 228 of the component 108 for an adjust beam 229. Also, the focusing lens 230 is preferably provided between the mirror 141 and the second surface 228 of the component 108. For example, the focusing lens 230 may be positioned in the window 198 of the objective mount 130 as described above. As described in more detail below, either the optical path 220 or 222 can be selected by moving the movable stage 128 to move the objective mount 130 into a position where a light beam 232 from the laser 132 is reflected by either the mirror 134 or 138.

As described above with respect to FIGS. 14 and 15, the optical system 105 of the tool head 102 of the apparatus 100 preferably includes the laser 132, mirrors 134, 135, 136, 137, 138, 139, 140, and 141, and the focusing lenses 226 and 230. This arrangement of optical components provides the apparatus 100 with the ability to adjust a performance parameter such as static attitude by selectively delivering a laser adjust beam (such as the beams 225 and 229) to oppositely facing surfaces of the component 108, which component may be a head suspension or head suspension assembly. Laser adjust beams (such as the beams 225 and 229) can also be delivered to oppositely facing surfaces of the component 108 at the same time (for example where plural lasers are used.) Moreover, because the adjust beams 225 and 229 move together with the focusing lenses 226 and 230, the adjust beams can be scanned across a surface of the component 108 by moving the objective mount 130.

The optical system 105 shown schematically in FIGS. 14 and 15 and described above is but one example of an optical system that can be used in accordance with the present invention. Any optical system can be used that is capable of selectively delivering one or more adjust beams to different surfaces of a component such as a head suspension or head suspension assembly for adjusting a performance parameter such as the static attitude of the component. Preferably, such an optical system is capable of selectively delivering one or more adjust beams to oppositely facing surfaces of a gimbal portion of a head suspension or a head suspension assembly when adjusting static attitude. When adjusting other performance parameters, an adjust beam can be delivered to any desired surface for adjusting a particular performance parameter. For example, when adjusting gram load, or spring geometry, an adjust beam can be delivered to a spring portion of a suspension. When adjusting load beam geometry, an adjust beam can be delivered to a load beam portion of a suspension. Accordingly, any optical components arranged in any manner can be used to form an optical system in accordance with the present invention. Preferably, the tool head 102 of the apparatus 100 is designed so that the working region 104 can be moved relative to the component 108 so that an adjust beam can be delivered to any desired portion of either side of the component 108. This can be done, for example, by selecting stages 118 and 128 to have sufficient travel for moving the working region (and an adjust beam) relating to the component 108. It is contemplated, however, that the component 108 may be moved in any manner to provide an adjust beam to a desired portion of the component 108.

As mentioned above, the optical path 220 can be selected by impinging the beam 232 from the laser 132 on the mirror 134. This can be accomplished by moving the movable stage 128 so that the objective mount 130 positions the mirror 134 with respect to the beam 232. The optical path 222 can be selected in a similar manner by impinging the beam 232 from the laser 132 on the mirror 138. Accordingly, the movable stage 128 can be used to move the objective mount 130 so that the mirror 138 is positioned with respect to the beam 232. Alternatively, it is contemplated that the laser 132 could be moved in order to selectively impinge the beam 232 on either of the mirror 134 or the mirror 138. It is further contemplated that multiple lasers could be used to selectively deliver an individual beam to the mirrors 134 and 138 or that the beam 232 could be split into multiple beams that could be selectively directed to the mirrors 134 and 138. In any case, the optical system 105 is preferably designed so that a laser adjust beam, for adjusting static attitude, can be delivered to one or more surfaces of a head suspension or head suspension assembly, either independently (by selecting a particular surface, or example) or simultaneously (selecting plural surfaces) for adjusting one or more performance parameters.

Preferably, in accordance with the present invention the optical system 105 is designed so that the ratio of the diameter of the spot size of an adjust beam (beam 226 and/or beam 229, for example) to the thickness of the material being adjusted is less than one. More preferably, the ratio of the diameter of spot size of an adjust beam to the thickness of the material being adjusted is less than 0.7. In other words, the diameter of spot size of adjust beam is preferably less than the thickness of the material being adjusted and more preferably less than 70 percent of the thickness of the material being adjusted. As an example, for a head suspension or head suspension assembly that has a gimbal portion that has a thickness of 10 microns, a preferred spot size diameter would be less than 10 microns and more preferably about 7 microns.

A spot size diameter that is less than the thickness of the material being adjusted provides significant advantages for adjusting static attitude as provided by the present invention. Bending occurs when thermal stresses are created in the material to be bent. Such thermal stresses can be created by heating an area of one side of the material so that a temperature gradient is created between oppositely facing surfaces of the material with respect to the heated area (across a material thickness, for example). In other words, a temperature gradient is provided through the thickness of the material by increasing the temperature of the material through a portion of its thickness. Where a laser beam is used to provide such heating, the thermal gradient is provided in the region that corresponds with the spot size diameter of the laser beam. As the material cools, thermal stresses are created because of differential thermal contraction of the material through its thickness. These stresses cause the material to bend, which bending can be controlled by controlling the application of heat to the material. Accordingly, by heating a smaller area of the material a greater adjust resolution can being provided. Moreover, increased adjust resolution can provide increased repeatability for adjusting static attitude. Combined with the ability to selectively direct an adjust beam to oppositely facing surfaces of a head suspension or a head suspension assembly, the present invention provides techniques for adjusting static attitude with increased resolution and with greater control especially in that the static attitude can be adjusted in plural directions.

In order to provide such spot sizes, the laser 132 preferably comprises a laser that is capable of being focused to have a spot size diameter in accordance with the present invention. As mentioned above, one such laser that can be used is a fiber laser. For example, ytterbium based fiber lasers as commercially available may be used. Also, gradient index focusing lenses are preferably used. However, any lenses that can provide spot sizes in accordance with the present invention can be used. For example, conventional lenses with focal lengths less than about 50 mm can be used to achieve such spot sizes.

The apparatus 100 described above can therefore be used to adjust a performance parameter such as static attitude of a head suspension or a head suspension assembly with greater control, accuracy, resolution, and repeatability than that previously known in the prior art. As described below with respect to one exemplary method of adjusting a performance parameter such as static attitude, the apparatus 100 provides many functional features and parameters that can be utilized for adjusting such performance parameters all of which may be controlled by a control system.

Preferably, a component such as the component 108 shown in FIG. 7, which can be a head suspension or head suspension assembly, is positioned in a measurement position with respect to the autocollimator 106. As described above, the component 108 can be provided in any desired manner such as by using the carrier strip 111 and/or the workpiece support 109 or the like. Also, the component 108 can be provided in a loaded or unloaded state for measuring static attitude with the autocollimator 106.

Preferably, when the component 108 is positioned in a measurement position with respect to the autocollimator 106, the tool head 102 is retracted in the y-axis so that the tool head 102 does not block a line of site between the autocollimator and the component 108. It is noted, however, that the autocollimator 106 can be positioned or movable in any manner so that the autocollimator 106 can measure the static attitude of the component 108 in accordance with the invention. It is contemplated, however, that the static attitude of the component 108 does not need to be measured and the component 108 can be adjusted in any desired manner as based on information or parameters (empirical, theoretical, etc.) related to a desired bending or adjust or desired static attitude.

After the autocollimator 106 has measured the static attitude of the component 108, the tool head 102 is preferably moved in the y-axis so that the component 108 is positioned in the working region 104 of the tool head 102. The tool head 102 can then be used to deliver an adjust beam to a surface of the component 108 for adjusting the static attitude of the component 108 by causing a predetermined portion of the component to bend as described above. For example, the object mount 130 can be moved into a position to select the optical path 220 for delivering the adjust beam 225 to the surface 224 of the component 108. As such, the static attitude can be adjusted in a first direction. If needed, the static attitude can be adjusted in a second direction. For example, the object mount 130 can be moved into a position to select the optical path 222 for delivering the adjust beam 229 to the surface 228 of the component 108.

Preferably, in order to cause a desired bend for adjusting static attitude, an adjust beam is scanned or traced across a surface of the component 108. Preferably, an electrical control system is used for controlling movements of the apparatus 100. The apparatus 100 therefore provides the ability to scan an adjust beam in any desired direction. For example, the movable stage 118 can be used to scan an adjust beam with respect to a surface of the component 108 in the y-axis. An adjust beam can also be scanned in the x-axis by moving the object mount 130 with the movable stage 128. For example, the mirror 134 can be translated in the x-axis with respect to the beam 232 thereby causing the adjust beam to also move in the x-axis. The same approach can be used with respect to the mirror 138 and adjust beam.

Typically, an adjust beam is scanned linearly in one or both of the x-axis and y-axis. However, it is contemplated that an adjust beam can be scanned in any desired direction and can change direction in any desired manner. In other words, an adjust beam does not need to be scanned linearly in order to adjust static attitude in accordance with the invention. An adjust beam can be scanned in a back and forth or zigzag pattern or in a curving manner for providing any desired bending effect for adjusting static attitude. An electrical control system can be used to control such scanning motion as well as for controlling aspects of the adjust beam such as an on or off state of the adjust beam, for example.

An adjust beam can be scanned in a continuous manner or may be pulsed depending on the desired bending effect that is desired. Also, other parameters can be used in order to control or provide a desired bending effect. Parameters such as the power density of the adjust beam as well as the scan rate of the adjust beam can be used in order to control the amount of energy or heat that is provided to the component 108. Control over any of these parameters can be integrated within the control functionality of a control system.

The apparatus 100 also provides the ability to focus an adjust beam with respect to a surface of the component 108. Preferably, the movable stage 120 is used to position an adjust beam on a surface of the component 108 so that a focal point of the adjust beam, as focused by a focusing lens, is focused on the desired surface. For example, the movable stage 120 (as controlled by a control system, for example) can be used to move the focal point of the adjust beam 225 in the z-axis so that the focal point is focused on the surface 224 of the component 108. Likewise, the focal point of the adjust beam 229 can be similarly focused on the surface 228 of the component 108. It is also contemplated that an adjust beam can be positioned with respect to a surface of the component 108 so that the adjust beam is out of focus with the surface. Such a technique can be used to increase or decrease the diameter of the spot size of an adjust beam in order to controllably provide a desired bending effect for adjusting static attitude.

In accordance with the present invention, the above-described bending is preferably correlated to a determination or measurement of the static attitude (or other performance parameter). That is, a desired or target static attitude may be determined prior to making an adjustment. As described above, determination of the static attitude or of the planar orientation of a surface can be accomplished by utilizing the preferred autocollimator 106. For example, the planar orientation of a slider mounting tongue or a slider to be adjusted may be determined and the above-described adjustment may be performed and the planar orientation remeasured until a desired planar orientation is accomplished. Additionally, the planar orientation of a reference surface may also preferably be determined and then utilized to accomplish a desired adjustment to the static attitude of the slider mounting tongue or the slider. That is, the planar orientation of a surface such as a surface of a load beam, flexure, gimbal arm, or any other surface may be used as a reference surface. In certain aspects of the present invention, a predictable relationship between the static attitude of head suspensions or head suspension assemblies in an unloaded state and a loaded state may be determined by measuring both the static attitude and the planar orientation of a reference surface such as a surface of a load beam. Such a relationship may also be based on theoretical and/or empirical data.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An apparatus for adjusting a performance parameter of a suspension of the type for use in a dynamic storage device, the apparatus comprising:
a working region capable of receiving a suspension as operatively supported therein;
a light source capable of providing an adjust beam that can be used to controllably heat a predetermined region of a suspension for adjusting a performance parameter of the suspension; and
a beam delivery device comprising a first optical path defining means that defines a first optical path that can provide the adjust beam to the working region in a first direction to impinge on a first surface of a suspension positioned in the working region and a second optical path defining means that defines a second optical path that can provide the adjust beam to the working region in a second direction to impinge on a second surface of a suspension positioned in the working region, the first optical path defining means comprising a first optical element movably positionable relative to the light source to direct the adjust beam along the first optical path and the second optical path defining means comprising a second optical element movably positionable relative to the light source to direct the adjust beam along the second optical path.

2. The apparatus of claim 1, wherein the first optical element of the first optical path defining means comprises a gradient index focusing lens.

3. The apparatus of claim 1, wherein the first optical path defining means comprises at least one mirror that can direct the adjust beam to the first optical element, the at least one mirror positioned between light source and the first optical element of the first optical path defining means.

4. The apparatus of claim 1, wherein the first optical path defining means is nonmovably positioned with respect to the light source.

5. The apparatus of claim 1, wherein the second optical element of the second optical path defining means comprises a gradient index focusing lens.

6. The apparatus of claim 1, wherein the second optical path defining means comprises at least one mirror that can direct the adjust beam to the second optical element, the at least one mirror positioned between the light source and the second optical element of the second optical path defining means.

7. The apparatus of claim 6, wherein the at least one mirror of the second optical path defining means is nonmovably positioned with respect to the light source.

8. The apparatus of claim 1, wherein the light source comprises a laser that can provide the adjust beam.

9. An apparatus for adjusting a performance parameter of a suspension of the type for use in a dynamic storage device, the apparatus comprising:
a working region capable of receiving a suspension as operatively supported therein;
a light source capable of providing an adjust beam that can be used to controllably heat a predetermined region of a suspension for adjusting a performance parameter of the suspension; and
beam delivery means that can receive the adjust beam from the light source and direct the adjust beam to the working region along an optical path, the beam delivery means comprising a focusing device and the beam delivery means movable relative to the light source so that the focusing device and the adjust beam can be moved relative to each other to scan the adjust beam across a surface of a suspension positioned in the working region.

10. The apparatus of claim 9, wherein the focusing device comprises a gradient index focusing lens.

11. The apparatus of claim 9, wherein the beam delivery means comprises at least one mirror positioned between the light source and the focusing device that can direct the adjust beam to the focusing device.

12. The apparatus of claim 11, wherein the at least one mirror of the beam delivery means is nonmovably positioned with respect to the light source.

13. The apparatus of claim 9, wherein the beam delivery means can receive the adjust beam from the light source and direct the adjust beam to the working region along a second optical path, the beam delivery means comprising a second focusing device and the beam delivery means movable relative to the light source so that the second focusing device and the adjust beam can be moved relative to each other to scan the adjust beam across a second surface of a suspension positioned in the working region.

14. The apparatus of claim 13, wherein the second focusing device comprises a gradient index focusing lens.

15. The apparatus of claim 13, wherein the beam delivery means comprises at least one mirror positioned between the light source and the second focusing device that can direct the adjust beam to the second focusing device.

16. The apparatus of claim 15, wherein the at least one mirror of the beam delivery means is nonmovably positioned with respect to the light source.

17. A method for adjusting a performance parameter of a suspension of the type for use in a dynamic storage device, the method comprising the steps of:
positioning a head suspension in a working position;
supplying an adjust beam from a light source provided at a spaced position from the working position of the head suspension;
directing the adjust beam to impinge on a first surface of the suspension by movably positioning a mirror of a first optical path relative to the adjust beam to direct the adjust beam to a focusing lens that moves together with the mirror; and
adjusting a predetermined performance parameter of the suspension in a first adjust direction.

18. The method of claim 17, further comprising the step of directing the adjust beam to impinge on a second surface of the suspension by movably positioning an optical path defining element of a second optical path relative to the adjust beam.

19. The method of claim 17, wherein the light source comprises a laser light source.

20. The method of claim 19, wherein the laser light source comprises a fiber laser light source.

21. The method of claim 18, wherein the first and second surfaces comprise oppositely facing surfaces of a portion of the suspension.

22. The method of claim 17, further comprising the step of scanning the adjust beam across the first surface of the suspension.

23. The method of claim 22, further comprising the step of moving the adjust beam with respect to the suspension.

24. The method of claim 18, further comprising the step of scanning the adjust beam across the second surface of the suspension.

25. The method of claim 24 further comprising the step of moving the adjust beam with respect to the suspension

26. The method of claim 18, further comprising the step of directing the adjust beam to impinge on the first surface of the suspension before directing the adjust beam to impinge on the second surface of the suspension.

27. The method of claim 17, wherein the focusing lens comprises a gradient index focusing lens.

28. The method of claim 27, further comprising the step of moving the adjust beam together with the gradient index focusing lens to adjust the predetermined performance parameter of the suspension.

29. The method of claim 18, wherein the second optical path defining element comprises a gradient index focusing lens.

30. The method of claim 29, further comprising the step of moving the adjust beam together with the gradient index focusing lens to adjust the predetermined performance parameter of the suspension.

31. The method of claim 17, wherein the predetermined performance parameter comprises at least one of static attitude, gram load, spring geometry, and beam geometry.

32. A method for adjusting a performance parameter of a suspension of the type for use in a dynamic storage device, the method comprising the steps of:
providing a suspension;
providing a light source;
providing a focused adjust beam by focusing a beam from the light source with a focusing lens;
directing the focused adjust beam to impinge on a surface of the suspension;
scanning the focused adjust beam across the surface of the suspension by moving the focused adjust beam together with the focusing lens; and
adjusting a predetermined performance parameter of the suspension in an adjust direction by controllably heating a predetermined region of the suspension.

33. The method of claim 32, wherein the predetermined performance parameter of the suspension comprises the static attitude of the suspension.

34. The method of claim 33, wherein the step of directing the focused adjust beam to impinge on a surface of the suspension comprises directing the adjust beam to impinge on a surface of a gimbal portion of the suspension to adjust the static attitude of the suspension.

35. The method of claim 32, wherein the predetermined performance parameter of the suspension comprises the gram load of the suspension.

36. The method of claim 35, wherein the step of directing the focused adjust beam to impinge on a surface of the suspension comprises directing the adjust beam to impinge on a surface of a spring portion of the suspension to adjust the gram load of the suspension.

37. The method of claim 32, wherein the predetermined performance parameter of the suspension comprises the spring geometry of the suspension.

38. The method of claim 37, wherein the step of directing the focused adjust beam to impinge on a surface of the suspension comprises directing the adjust beam to impinge on a surface of a spring portion of the suspension to adjust the spring geometry of the suspension.

39. The method of claim 32, wherein the predetermined performance parameter of the suspension comprises the load beam geometry of the suspension.

40. The method of claim 39, wherein the step of directing the focused adjust beam to impinge on a surface of the suspension comprises directing the focused adjust beam to impinge on a surface of a load beam portion of the suspension to adjust the load beam geometry of the suspension.

41. The method of claim 32, wherein the light source comprises a fiber laser light source.

42. The method of claim 32, further comprising the step of directing the focused adjust beam to impinge on a second surface of the suspension for adjusting the predetermined performance parameter of the suspension in a second adjust direction.

43. The method of claim 42, further comprising the step of scanning the focused adjust beam across the second surface of the suspension.

44. The method of claim 42, further comprising the step of directing the focused adjust beam to impinge on the first surface of the suspension before directing the focused adjust beam to impinge on the second surface of the suspension.

45. The method of claim 32, further comprising the step of using information comprising a measurement of the predetermined performance parameter of the suspension to adjust the predetermined performance parameter.

46. The method of claim 32, wherein the step of focusing a beam from the light source comprises focusing the light source with a gradient index lens.

47. A method for adjusting a performance parameter of a suspension of the type for use in a dynamic storage device, the method comprising the steps of:
impinging a laser adjust beam on a surface of a portion of a suspension wherein the spot size diameter of the laser adjust beam is smaller than the thickness of the portion of the suspension;
focusing the laser adjust beam with a focusing lens;
scanning the laser adjust beam along the surface of the suspension by moving the adjust beam together with the focusing lens; and
controllably heating a predetermined region of the surface of the suspension and adjusting the predetermined performance parameter of the suspension.

48. The method of claim 47, wherein the focusing lens comprises a gradient index lens.

49. The method of claim 47, wherein the focusing lens comprises a focal length of about 50 mm or less.

50. The method of claim 47, wherein the laser adjust beam comprises a beam from a fiber laser.

51. The method of claim 47, wherein the predetermined performance parameter comprises at least one of static attitude, gram load, spring geometry, and beam geometry.
